(19) United States
(12) Patent Application Publication
(10) Pub. No.: US 2026/0040179 A1
(43) Pub. Date: Feb. 5, 2026

(54) METHOD AND APPARATUS FOR PERFORMING COMMUNICATION IN WIRELESS COMMUNICATION SYSTEM

(71) Applicant: Samsung Electronics Co., Ltd., Suwon-si, Gyeonggi-do (KR)

(72) Inventors: Aby Kanneath ABRAHAM, Bangalore (IN); Vinay Kumar SHRIVASTAVA, Bangalore (IN); Sriganesh RAJENDRAN, Bangalore (IN)

(21) Appl. No.: 18/998,340

(22) PCT Filed: Jul. 25, 2023
(86) PCT No.: PCT/KR2023/010761

§ 371 Date: Jan. 24, 2025

(30) Foreign Application Priority Data
Jul. 27, 2022 (IN) 202241043118
Jun. 26, 2023 (IN) 2022 41043118

(51) Int. Cl. H04W 36/30; H04W 36/00

(52) U.S. Cl. CPC H04W 36/305; H04W 36/0058

(57) ABSTRACT

The disclosure relates to a 5G or 6G communication system for supporting a higher data transmission rate. A method performed by a user equipment (UE) supporting a fast Master Cell Group (MCG) link recovery for Multi Radio-Dual Connectivity (MR-DC) is provided. The method comprising: initiating the fast MCG link recovery, based on occurrence of a radio link failure (RLF) in MCG; and in case that failure of the fast MCG link recovery is identified, transmitting a RLF report including cause information indicating at least one of expiry of a timer, secondary cell group (SCG) deactivation or SCG failure.

### TECHNICAL FIELD

Embodiments disclosed herein relate to wireless communication networks, and more particularly to managing fast Master Cell Group (MCG) link recovery for Multi Radio-Dual Connectivity (MR-DC).

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mm Wave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyperconnectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Solution to Problem

The object of embodiments herein may relate to disclose methods and systems for handling a fast Master Cell Group (MCG) link recovery for Multi Radio-Dual Connectivity (MR-DC) scenarios in wireless communication networks.

According to an embodiment of this disclosure, a method performed by a user equipment (UE) supporting a fast Master Cell Group (MCG) link recovery for Multi Radio-Dual Connectivity (MR-DC) is provided. The method may include initiating the fast MCG link recovery, based on occurrence of a radio link failure (RLF) in MCG. The method may include, in case that failure of the fast MCG link recovery is identified, transmitting a RLF report including cause information indicating at least one of expiry of a timer, secondary cell group (SCG) deactivation or SCG failure.

According to an embodiment of this disclosure, a User Equipment (UE) is provided. The UE may comprise a transceiver; and a processor coupled with the transceiver. The processor may be configured to initiate a fast master cell group (MCG) link recovery, based on occurrence of a radio link failure (RLF) in MCG. The processor may be configured to transmit a RLF report including cause information indicating at least one of expiry of a timer, secondary cell group (SCG) deactivation or SCG failure in case that failure of the fast MCG link recovery is identified.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 illustrates a system for managing an MCG link recovery for MR-DC scenarios, according to embodiments as disclosed herein;

FIG. 2 illustrates block representation of a plurality of modules of a processor of UE, according to embodiments as disclosed herein;

FIG. 3 illustrates a method for managing a fast MCG link recovery for MR-DC, according to embodiments as disclosed herein;

FIG. 4 illustrates a method for managing the logged RLF report by the UE, according to embodiments as disclosed herein;

FIG. 5 illustrates a flow diagram depicting the fast MCG link recovery behaviour when SRB2 or DRB/MRB is not available, according to embodiments as disclosed herein;

FIG. 6 is a flow diagram depicting the fast MCG Link recovery behaviour, on T316 timer expiry, according to embodiments as disclosed herein;

FIG. 7 is a flow diagram depicting the fast MCG link recovery behaviour, when SCG status is unsuitable, according to embodiments as disclosed herein;

FIG. 8 is a flow diagram depicting a fast MCG link recovery behaviour, when there is an SCG failure, according to embodiments as disclosed herein;

FIG. 9 is a flow diagram depicting a successful fast MCG link recovery, according to embodiments as disclosed herein;

FIG. 10 illustrates a method for depicting a process of handling RLF reports during a successful fast MCG link recovery, according to embodiments as disclosed herein; and

FIG. 11 illustrates a method depicting the process of handling SHR/Inter-RAT SHR during fast MCG link recovery, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Dual connectivity or more technically Multi-Radio Dual Connectivity (MR-DC) is specified by 3GPP in specifications such as TS 37.340. Next-Generation Radio Access Network (NG-RAN) supports the MR-DC operation, whereby a user equipment (UE) in a Radio Resource Control (RRC) connected (RRC_CONNECTED) state is configured to utilize radio resources provided by two distinct schedulers, located in two different NG-RAN nodes. The NG-RAN nodes are connected via a non-ideal backhaul, where one node can provide NR (New Radio) access and the other node can provide either Evolved UMTS Terrestrial Radio Access (E-UTRA) or NR access. One node acts as a Master Node (MN) and the other node acts as a Secondary Node (SN). The MN and SN are connected via a network interface and at least the MN is connected to the core network. NG-RAN supports NG-RAN E-UTRA-NR Dual Connectivity (NGEN-DC), in which a UE is connected to one NG-NB (an E-UTRA base station that can connect to 5G core) that acts as MN and one gNB (5G base station) that acts as the SN. NG-RAN also supports NR-E-UTRA Dual Connectivity (NE-DC), in which a UE is connected to one gNB that acts as MN and one NG-eNB that acts as the SN. Radio link failures may occur in any of the MCG (Master Cell Group) and SCG (Secondary Cell Group) links due to reasons such as expiry of RRC timers T310, T312, and T304, inability to comply with the provided configuration, failure to successfully move to a target cell during a handover or other kinds of mobility such as lower layers triggered mobility (LTM).

The UE sends MCG failure information (for e.g. NR (RRC Radio Resource Control) message MCGFailureInformation) to report MCG radio link failures to a Secondary Cell Group (SCG). A fast MCG link recovery procedure may be performed by the network after receiving the MCG failure information. The network sends an MCG reconfiguration message through the SCG to recover the MCG. After initiating the MCG failure information, the UE starts a timer (hereinafter referred to as a T316 timer) as configured by the network. If the UE does not receive the RRC response message such as MCG RRC reconfiguration message or RRC Release message before the expiry of the timer, the UE may initiate a RRC reestablishment procedure.

The fast MCG link recovery is detailed in 3GPP specifications like TS 38.331. The timer T316 is the fast MCG link recovery timer in NR and has been described in TS 38.331 specification. The UE initiates fast MCG link recovery during a RLF if T316 is configured by the network. Even when the network has configured the T316 timer for Fast MCG link recovery, the UE may not be able to send MCGFailureInformation to initiate the same, for example due to the issues with SCG or the SCG being in deactivated state or there is no specific radio bearers such as NR signaling radio bearer 2 (SRB2) or Data radio bearer DRB or MBS Radio Bearer (MRB), which denotes radio bearers carrying both multicast and broadcast sessions. Similarly the fast MCG link recovery itself may fail due to errors in SCG link such as failures in SCG. It is quite important to identify these issues and resolve them in the network nodes so that UE's don't suffer performance issues. A related issue is that the UE might have initiated fast MCG link recovery, yet the network was not able to send a RRC response message within the T316 timer duration. In this scenario, the UE suffers even worse performance than the case where fast MCG link recovery was not initiated since the subsequent RRC Reestablishment is also delayed. In traditional systems, a UE which has performed fast MCG link recovery doesn't store the RLF report when the fast MCG link recovery is successful.

### Self-Optimization in NR:

A 5G NR radio access network also known as NG-RAN comprises of a number of NR base stations (known as gNBs). The gNBs can be connected to each other through a Xn interface, and can be connected to various core network elements (such as Access and Mobility Management Function (AMF), a User Plane Function (UPF), and so on). Further, the gNBs can be divided into two physical entities, named as a Centralized Unit (CU) and a Distributed Unit (DU). The CU provides support for the higher layers of the protocol stack (such as a Session Data Application Protocol (SDAP), a Packet Data Convergence Protocol (PDCP), and RRC). The DU provides support for the lower layers of the protocol stack (such as an RLC (Radio Link Control), MAC (Medium Access Control) and Physical layer). Each gNB can have multiple cells serving many UEs. There are a large number of algorithms and configuration parameters used in NG-RAN. Especially, it is a very difficult task to identify the most optimal radio parameters and operators used to resort to manual techniques like drive tests to identify the parameters. However, such manual parameter tuning is a costly operation since it depends on a lot of factors like the number of users, number of neighbors, maximum throughput in the cell, average throughput in the cell and so on. Further, when a neighbor gNB is installed or a new service is introduced, many of these manual operations need to be repeated. To resolve this problem, 3GPP has introduced Self-Organizing Networks (SON) techniques in the wireless technologies like NR. The SON was first introduced in 3GPP release 9, in Long Term Evolution (LTE). SON solutions can be divided into three categories: Self-Configuration, Self-Optimization and Self-Healing. The SON architecture can be a centralized, distributed or a hybrid solution.

From TS 38.300 V17.0.0, a mobility robustness optimization aims at detecting and enabling correction of the following problems:
Connection failure due to intra-system or inter-system mobility;
Inter-system Unnecessary HandOver (HO) (too early inter-system HO from NR to E-UTRAN with no radio link failure); and
Inter-system HO ping-pong.

The UE stores various reports and sends them to the network for aiding the SON, particularly for Mobility optimization. The UE may log RLF reports (Radio Link Failure) report for the SON purpose. However, the optimizations needed for the fast MCG link recovery are not available in the RLF Report. It is also noted that in the traditional systems, if fast MCG link recovery is successful (i.e., if the UE has received a RRC response message for the fast MCG link recovery message such as MCGFailureInformation), the UE clears the logged RLF report, and there is no way by which the network can retrieve this information about the RLF through RLF reports.

An object of embodiments herein is to disclose methods and systems for handling a fast Master Cell Group (MCG) link recovery for Multi Radio-Dual Connectivity (MR-DC) scenarios in wireless communication networks.

Another object of embodiments herein is to disclose methods and systems for reporting failure reasons for the fast MCG link recovery, to the network.

Another object of embodiments herein is to disclose methods and systems for clearing (reporting) or keeping (storing) a Radio Link Failure (RLF) report, based on configuration of reporting of the fast MCG link recovery.

Another object of embodiments herein is to disclose methods and systems for configuring a Successful Handover Report (SHR) for fast MCG link recovery.

Accordingly, the embodiments herein provide a method for managing a fast Master Cell Group (MCG) link recovery for Multi Radio-Dual Connectivity (MR-DC). The method comprises configuring, by a User Equipment (UE), the fast MCG link recovery. The fast MCG link recovery is configured by a network, wherein the configuration comprises of a timer. The method includes initiating, by the UE, the fast MCG link recovery, if a Radio Link Failure (RLF) has occurred in MCG. The method includes logging, by the UE, in RLF report indicating status of the fast MCG link recovery. The method includes storing, by the UE, the logged RLF report.

Accordingly, the embodiments herein provide a UE which comprises a processor. The processor is configured to configure the fast MCG link recovery. The fast MCG link recovery is configured by the network, wherein the configuration comprises of a timer. The processor is configured to initiate the fast MCG link recovery, if an RLF occurs in MCG. The processor is configured to log the RLF report indicating status of the fast MCG link recovery. The processor is further configured to store the logged RLF report.

Accordingly, the embodiments herein provide a network which comprises a processor. The processor is configured to receive at least one UE capability information from a UE. The UE capability information informs whether the UE is capable of supporting Self-Organizing Network (SON)/Minimization of Drive Test (MDT) enhancements for the fast Master Cell Group (MCG) link recovery. The processor is configured to receive the RLF report from the UE indicating the status of the fast MCG link recovery, if an RLF occurs in MCG and the UE is capable of supporting the SON/MDT enhancements for the fast MCG link recovery. The processor is configured to perform a plurality of optimizing procedures for optimizing mobility of the UE using the received status of the fast MCG link recovery.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

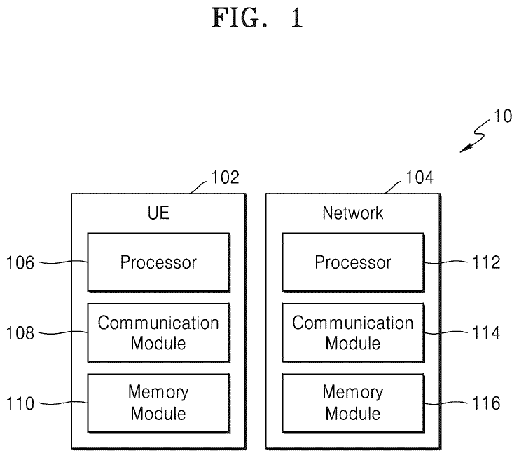

The embodiments herein provide methods and systems for handling a fast Master Cell Group (MCG) link recovery for Multi Radio-Dual Connectivity (MR-DC) scenarios in wireless communication networks. Referring now to the drawings, and more particularly to FIGS. 1 through 11, where similar reference characters denote corresponding features consistently throughout the figures, there are shown embodiments.

FIG. 1 illustrates a system 100 for managing an MCG link recovery for MR-DC scenarios. The system 100 comprises a User Equipment (UE) 102 and a network 104. The network 104 can be a radio access node (such as a base station (gNB)) or a core network node (such as an Access and Mobility Management Function (AMF)). The UE 102 further comprises a processor 106, a communication module 108, and a memory module 110. In this disclosure, the communication module 108 is also explained as a transceiver.

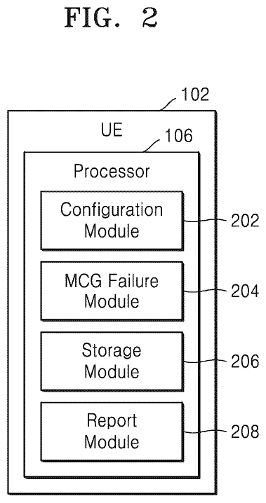

In an embodiment herein, the processor 106 of the UE 102 is configured to log and report various parameters for the fast MCG link recovery, to the network 104, including the status of the fast MCG link recovery and a plurality of information for a fast MCG link recovery failure. The processor 106 is configured to perform the fast MCG link recovery for a handover request from the network 104 and report successful handover to the network 104. The processor 106 further comprises a configuration module 202, an MCG failure module 204, a storage module 206, and a report module 208, as depicted in FIG. 2.

In an embodiment herein, the configuration module 202 can configure the fast MCG link recovery, using a configuration received from the network 104. The configuration of the fast MCG link recovery that is received from the network 104 comprises of a timer. The configured timer is a T316 timer. In an embodiment herein, the configuration module 202 can send at least one UE capability information to the network 104. The UE capability information informs whether the UE 102 is capable of supporting Self-Organizing Network (SON)/Minimization of Drive Test (MDT) enhancements for the fast MCG link recovery.

In an embodiment herein, the MCG failure module 204 can initiate the fast MCG link recovery, if a Radio Link Failure (RLF) or MCG RLF has occurred in MCG. The MCG failure module 204 can log a RLF report indicating status of the fast MCG link recovery. The MCG failure module 204 can log the fast MCG link recovery, when the fast MCG link recovery has not been initiated. The fast MCG link recovery may not be initiated, for example, due to at least one of: an SCG transmission has been suspended, a Primary and Secondary cell (PS Cell) change/PS Cell addition is ongoing, reconfiguration with synchronous (sync) failure for SCG while MCG has been suspended, SCG is deactivated, an Access stratum (AS) security has not been activated, and a Data Radio Bearer (DRB)/Multicast Radio Bearer (MRB) or a Signaling Radio Bearer (SRB) has not been configured.

In an embodiment herein, the RLF report indicates the status of the fast MCG link recovery. The status comprises at least one of the fast MCG link recovery has not been initiated, the fast MCG link recovery has been initiated and was successful, and the fast MCG link recovery has been initiated and was unsuccessful. The status of the fast MCG link recovery has not been initiated indicates that an MCG failure information has not been transmitted to the network 104 when the configured timer T316 has been configured and AS security has been activated. The status of the fast MCG link recovery has been initiated and was successful, indicates that the MCG failure information has been successfully transmitted to the network 104 and the UE 102 has received a Radio Resource Control (RRC) response message from the network 104 within the configured T316 timer. The UE 102 logs at least one of an elapsed timer value, and a ratio in percentage of the elapsed timer and the configured timer to indicate the status of the fast MCG link recovery has been initiated and was successful. The UE 102 may skip including the status when it logs the elapsed timer value or ratio in percentage of the elapsed timer and the configured timer, and the network 104 can easily deduce the status based on the presence of the elapsed timer value or the ratio and the absence of other status values. The status of the fast MCG link recovery has been initiated and was unsuccessful indicates that the MCG failure information has been successfully transmitted to the network 104 and the UE 102 has not been received the RRC response message from the network 104 within the configured T316 timer. In an embodiment herein, the status of the fast MCG link recovery has been initiated and was unsuccessful indicates that the MCG failure information has been successfully transmitted to the network 104 and the configured T316 timer has been stopped due to one or more failures faced by the UE 102 while waiting for the RRC response message from the network 104.

In an embodiment herein, the RRC response message from the network 104 comprises at least one of a mobility from New Radio (NR) command message, a mobility from Evolved Universal Terrestrial Radio Access (EUTRA) command message, an RRC reconfiguration message, and an RRC release message.

In an embodiment herein, the MCG failure module 204 logs a plurality of information in the RLF report to indicate the status of the fast MCG link recovery, when the fast MCG link recovery has not been initiated or was unsuccessful. The plurality of information can comprise, but not limited to, an SCG was deactivated at the time of initiation of the fast MCG link recovery, the UE 102 has not been received the RRC response message from the network 104 within the configured T316 timer, a RLF at SCG, a configured timer T312 expired at SCG, and common failures at SCG. The plurality of information can also comprise a timer T310 expired at SCG, and T304 timer expired at SCG etc. Storing the exact reason of SCG failure helps the network 104 in detailed analysis at the network 104, but it consumes more resources in the UE 102 and network 104 (memory/signaling). Hence, a balanced approach could be provided by storing a common error cause for some cases and for storing the actual error cause for some other cases. The UE 104 determines the cases for which a common (generic/other) error causes to be stored based on the prioritization of the seriousness of error. Further, the common failures at SCG comprises at least one of: inability of the UE 102 to comply with the SCG RRC response message, a Lower-layer Triggered Mobility (LTM) cell switch failure, and inability of the UE 102 to comply with the SCG LTM candidate configuration. Further, the common causes for which the UE has not initiated MCG fast recovery can be MCG transmission is suspended, and SCG transmission is suspended.

In an embodiment herein, the storage module 206 can receive and store the logged RLF report from the MCG failure module 204. The storage module 206 can store the logged RLF report based on the request from the network 104. In an embodiment herein, the storage module 206 can verify at least one configured condition, if the fast MCG link recovery has been initiated and was successful. The conditions comprise if the UE 102 supports the SON/MDT enhancements for the fast MCG link recovery, and if the UE 102 has logged the plurality of information about the fast MCG link recovery in the RLF report. For example, a UE 102 may support SON/MDT enhancements for fast MCG link recovery if it supports NR Release 18 and it supports fast MCG link recovery. In another example, a UE 102 may support SON/MDT enhancements for fast MCG link recovery if it supports NR Release 18, fast MCG link recovery, and logging and reporting of the RLF report. The storage module 206 stores the logged RLF report and sends the logged RLF report to the network 104, if at least one condition is satisfied. The storage module 206 releases the logged RLF report, if at least one condition is not satisfied.

In an embodiment herein, the report module 208 can receive a request from the network 104 either to store the RLF report in the storage module 206 or to send the RLF report to the network 104, based on the MCG failure information and the UE capability information. The report module 208 can report the logged RLF report to the network 104. The report module 208 can report the fast MCG link recovery, when the fast MCG link recovery has not been initiated.

The network 104 further comprises a processor 112, a communication module 114, and a memory module 116. In this disclosure, the communication module 114 is also explained as a transceiver.

In an embodiment herein, the processor 112 can receive at least one UE capability information from the configuration module 202 of the UE 102. The UE capability information informs whether the UE 102 is capable of supporting the SON/MDT enhancements for the fast MCG link recovery. The processor 112 can send a request to the report module 208 of the UE 102 either to store the RLF report or to send the RLF report to the network 104, based on the received MCG failure information and the UE capability information. The processor 112 of the network 104 can transmit the request to store the RLF report or to send the RLF report through a flag.

In an embodiment herein, the processor 112 can receive the RLF report from the report module 208 of the UE 102, if the processor 112 requests the UE 102 to transmit the RLF report. The RLF report indicates the status of the fast MCG link recovery, if an RLF occurs in MCG and the UE 102 is capable of supporting the SON/MDT enhancements for the fast MCG link recovery. The processor 112 can perform a plurality of optimizing procedures for optimizing mobility of the UE 102 using the received status of the fast MCG link recovery. The optimizing procedures can comprise correction of one or more problems. Examples of the problems can be, but not limited to, a connection failure due to intra-system or inter-system mobility, inter-system unnecessary HandOver (HO) (too early inter-system HO from NR to Evolved UMTS Terrestrial Radio Access Network (E-UTRAN) with no radio link failure), and intersystem HO ping-pong. The Optimizing procedure may adjust the value of timer such as T316 based on the received information.

In an embodiment herein, the processor 106 can process and execute data of a plurality of modules of the UE 102 respectively. The processor 106 can be configured to execute instructions stored in the memory module 110. The processor 106 may comprise one or more of microprocessors, circuits, and other hardware configured for processing. The processor 106 can be at least one of a single processer, a plurality of processors, multiple homogeneous or heterogeneous cores, multiple Central Processing Units (CPUs) of different kinds, microcontrollers, special media, and other accelerators. The processor 106 may be an application processor (AP), a graphics-only processing unit (such as a graphics processing unit (GPU), a visual processing unit (VPU)), and/or an Artificial Intelligence (AI)-dedicated processor (such as a neural processing unit (NPU)).

In an embodiment herein, the processor 112 can process and execute data of a plurality of modules of the network 104 respectively. The processor 112 can be configured to execute instructions stored in the memory module 116. The processor 112 may comprise one or more of microprocessors, circuits, and other hardware configured for processing. The processor 112 can be at least one of a single processer, a plurality of processors, multiple homogeneous or heterogeneous cores, multiple Central Processing Units (CPUs) of different kinds, microcontrollers, special media, and other accelerators. The processor 112 may be an application processor (AP), a graphics-only processing unit (such as a graphics processing unit (GPU), a visual processing unit (VPU)), and/or an Artificial Intelligence (AI)-dedicated processor (such as a neural processing unit (NPU)).

In an embodiment herein, the plurality of modules of the processor 106 of the UE 102 can communicate with the network 104 via the communication module 108. The processor 112 of the network 104 can communicate with the UE 102 via the communication module 114. The communication modules 108 and 114 may be in the form of either a wired network or a wireless communication network module. The wireless communication network may comprise, but not limited to, Global Positioning System (GPS), Global System for Mobile Communications (GSM), Wi-Fi, Bluetooth low energy, Near-field communication (NFC), and so on. The wireless communication may further comprise one or more of Bluetooth, ZigBee, a short-range wireless communication (such as Ultra-Wideband (UWB)), and a medium-range wireless communication (such as Wi-Fi) or a long-range wireless communication (such as 3G/4G/5G/6G and non-3GPP technologies or WiMAX), according to the usage environment.

In an embodiment herein, the memory module 110 may comprise one or more volatile and non-volatile memory components which are capable of storing data and instructions of the modules of the UE 102 to be executed. Examples of the memory module 110 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 110 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 110 may, in some examples, be considered a non-transitory storage medium. The term “non-transitory” may indicate that the storage medium is not embodied in a carrier wave or a propagated signal. However, the term “non-transitory” should not be interpreted to mean that the memory module 110 is non-movable. In certain examples, a non-transitory storage medium may store data that can, over time, change (for example, in Random Access Memory (RAM) or cache).

In an embodiment herein, the memory module 116 may comprise one or more volatile and non-volatile memory components which are capable of storing data and instructions of the modules of the network 104 to be executed. Examples of the memory module 116 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 116 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 116 may, in some examples, be considered a non-transitory storage medium. The term “non-transitory” may indicate that the storage medium is not embodied in a carrier wave or a propagated signal. However, the term “non-transitory” should not be interpreted to mean that the memory module 116 is non-movable. In certain examples, a non-transitory storage medium may store data that can, over time, change (for example, in Random Access Memory (RAM) or cache).

FIG. 1 and FIG. 2 show example modules of the system 100 and the UE 102 respectively, but it is to be understood that other embodiments are not limited thereon. In other embodiments, the system 100 and the UE 102 may include less or more number of modules. Further, the labels or names of the modules are used only for illustrative purpose and does not limit the scope of the invention. One or more modules can be combined together to perform same or substantially similar function in the system 100 and the UE 102.

Embodiments herein consider the fast MCG link recovery, from the UE 102 sending the MCG failure information to the network 104 and starting T316 timer, till the network 104 reconfiguring MCG link or releasing the RRC connection after receiving the MCG failure information.

According to an embodiment of the disclosure, during a MCG RLF, if UE 102 has been configured with timer T316 and has started T316, the UE may store indication that T316 has been started and MCG failure information has been sent, in RLF report.

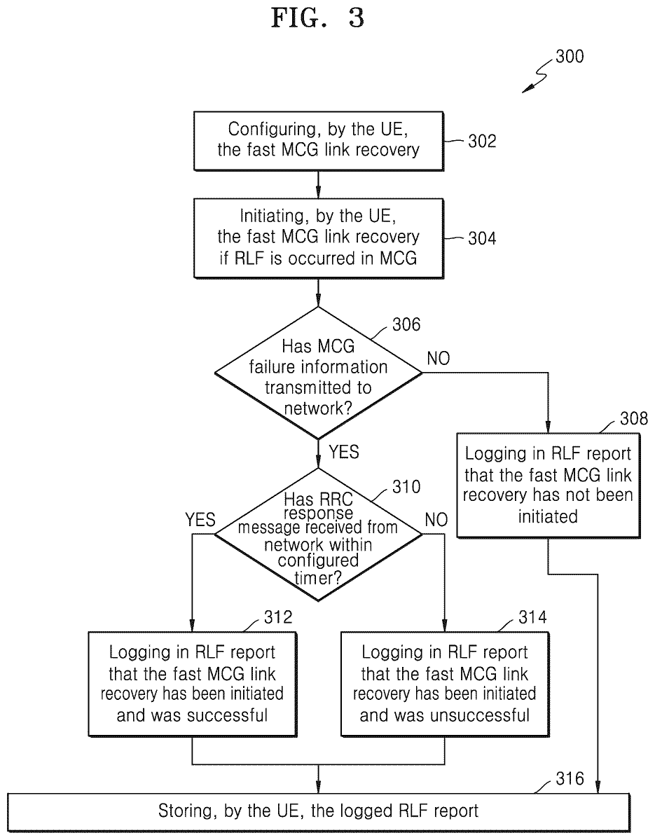

FIG. 3 illustrates a method 300 for managing a fast MCG link recovery for MR-DC. The method 300 includes configuring, by the UE 102, the fast MCG link recovery, as depicted in step 302. The fast MCG link recovery is configured by the processor 112 of the network 104, wherein the configuration comprises of a T316 timer. The method 300 includes initiating, by the UE 102, the fast MCG link recovery, as depicted in step 304, if an RLF occurs in MCG. The method 300 includes verifying, by the UE 102, whether an MCG failure information has been successfully transmitted to the network 104, as depicted in step 306. If the MCG failure information has not been transmitted to the network 104, then a RLF report is logged, by the UE 102, indicating the status that the fast MCG link recovery has not been initiated, as depicted in step 308.

Thereafter, if the MCG failure information has been transmitted to the network 104, the UE 102 verifies whether an RRC response message has been received from the network 104 within the configured timer, as depicted in step 310. If the RRC response message has been received from the network 104, then the UE 102 logs a RLF report indicating the status that the fast MCG link recovery has been initiated and was successful, as depicted in step 312. The UE 102 may also add some additional information like the elapsed value of timer T316 or the ratio between elapsed value of timer T316 to the configured value of the timer T316. If the RRC response message has not been received from the network 104, then the UE 102 logs a RLF report indicating the status that the fast MCG link recovery has been initiated and was unsuccessful, as depicted in step 314. Later, the method 300 includes storing, by the UE 102, the logged RLF report, as depicted in step 316. The various actions in method 300 may be performed in the order presented, in a different order or simultaneously. Further, in some embodiments, some actions listed in FIG. 3 may be omitted.

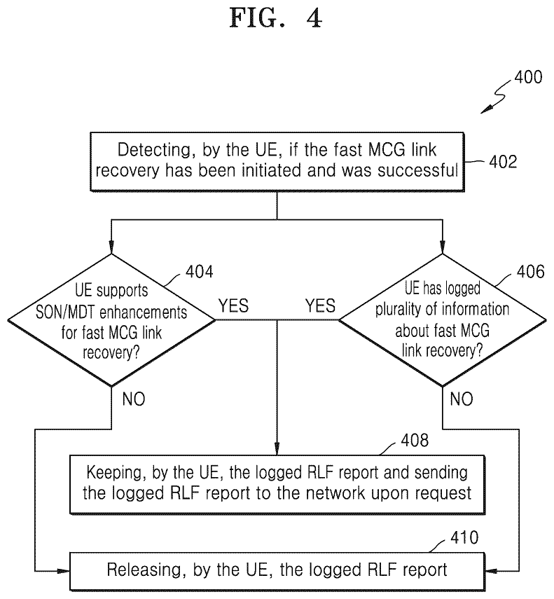

FIG. 4 illustrates a method 400 for managing the logged RLF report by the UE 102. The method 400 includes detecting, by the UE 102, if the fast MCG link recovery has been initiated and was successful, as depicted in step 402. The method 400 includes verifying, by the UE 102, two conditions simultaneously. One condition is to verify is if the UE 102 supports the SON/MDT enhancements for the fast MCG link recovery, as depicted in step 404. Other condition is to verify if the UE 102 has logged the plurality of information about the fast MCG link recovery in the RLF report, as depicted in step 406. If at least one condition is satisfied, then the UE 102 keeps the logged RLF report and sends the logged RLF report to the network 104, as depicted in step 408, upon request. If the conditions are not satisfied, then the UE 102 releases the logged RLF report, as depicted in step 410. The various actions in method 400 may be performed in the order presented, in a different order or simultaneously. Further, in some embodiments, some actions listed in FIG. 4 may be omitted.

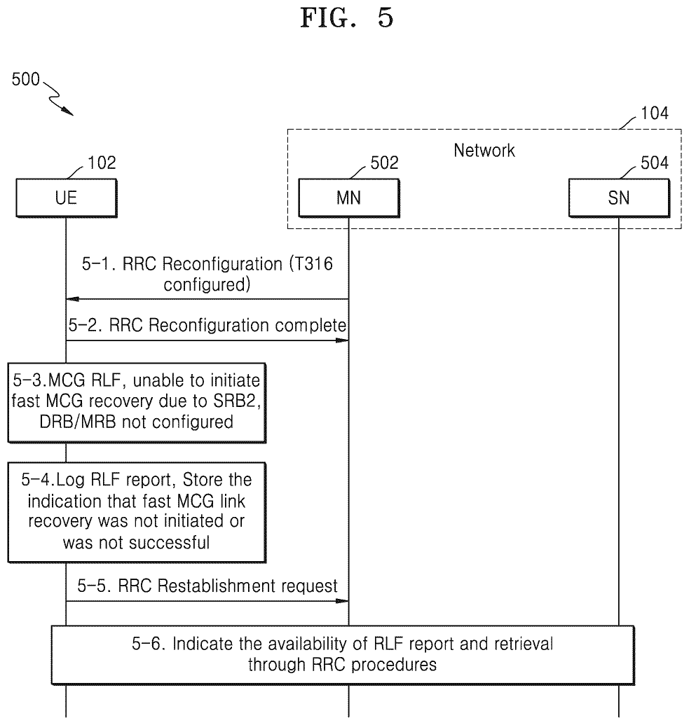

FIG. 5 illustrates a flow diagram 500 depicting the fast MCG link recovery behaviour when SRB2 or DRB/MRB is not available. As depicted in step 5-1, the Master Node (MN) 502 of the network 104 transmits an RRC reconfiguration message comprising configuration of the fast MCG Link Recovery and the configured T316 timer. The UE 102 configures the fast MCG Link Recovery and transmits an RRC reconfiguration complete message to the MN 502, as depicted in step 5-2.

As depicted in step 5-3, an MCG RLF occurs in the UE 102 and the UE 102 is unable to initiate the fast MCG recovery, as SRB2 or DRB/MRB is not configured in the UE 102. As depicted in step 5-4, the UE 102 logs the RLF report and stores the indication that the fast MCG link recovery was not initiated or was not successful. There are multiple alternatives possible to store the status that the bearer is unavailable. Instead of storing the specific reason (bearer unavailable), the UE 102 may just store that fast MCG recovery was not initiated due to a common error. In an alternative, if the fast MCG link recovery was not initiated due to SRB2 or DRB/MRB is not configured in the UE 102, the UE 102 may just store that fast MCG recovery has failed. In yet another alternative, the UE 102 checks whether the fast MCG link recovery was not initiated due to SRB2 or DRB/MRB is not configured in the UE 102, and if so the UE 102 avoids storing the fast MCG recovery related information in the RLF report.

For example, the UE 102 stores that fast MCG link recovery was not initiated due to a SCG condition (or SCG state, SCG error etc.) in the RLF report. Alternatively, the UE 102 stores the actual reason as to why the fast MCG link recovery was not initiated, in the RLF report. If the UE 102 has not been transmitted the MCG failure information (due to AS security not activated or DRB/multicast MRB or SRB2 was not configured), the UE 102 stores the corresponding reason. The UE 102 may store that the fast MCG link recovery was not successful, if the UE 102 is not able to initiate transmission of the MCG failure information.

The fast MCG link recovery may not be initiated, for example, due to at least one of: an SCG transmission has been suspended, a Primary and Secondary cell (PS Cell) change/PS Cell addition is ongoing, reconfiguration with synchronous (sync) failure for SCG while MCG has been suspended, SCG is deactivated, an Access stratum (AS) security has not been activated, and a Data Radio Bearer (DRB)/Multicast Radio Bearer (MRB) or a Signaling Radio Bearer (SRB) has not been configured.

In an alternate embodiment herein, if the fast MCG link recovery was not initiated due to AS security not activated, then the UE 102 avoids storing RLF report with the fast MCG link recovery related information. In an embodiment herein, the UE 102 checks if the SRB3 (SRB on SCG) or split SRB (SRB split between MCG and SCG) are configured, before storing fast MCG link recovery related information even when T316 is configured and AS security is activated, and if either SRB3/Split SRB is not configured then the UE 102 avoids storing RLF report with the fast MCG link recovery related information.

After logging the RLF report, the UE 102 transmits an RRC reestablishment request to the MN 502, as depicted in step 5-5. The UE 102 further indicates the availability of the RLF report and retrieval of the RLF report through RRC procedures to the MN 502 and a secondary node (SN) 504 of the network 104, as depicted in step 5-6. In an embodiment herein, if the UE 102 has initiated the MCG failure information transmission and a SCG failure occurred (for example, an SCG RLF has occurred or there is an inability to comply with an SCG RRC Reconfiguration for SCG), then the UE 102 may log that the fast MCG link recovery was initiated, but was not successful in the RLF report. The UE 102 may log that the fast MCG link recovery was not successful due to an error/failure in the SCG in the RLF report.

To keep a balance between the UE 102 implementation complexity, signaling overhead over the air and the efficiency of SON, the UE 102 may report the reason for the SCG failure for a few errors and for a few others UE 102 may report a general failure.

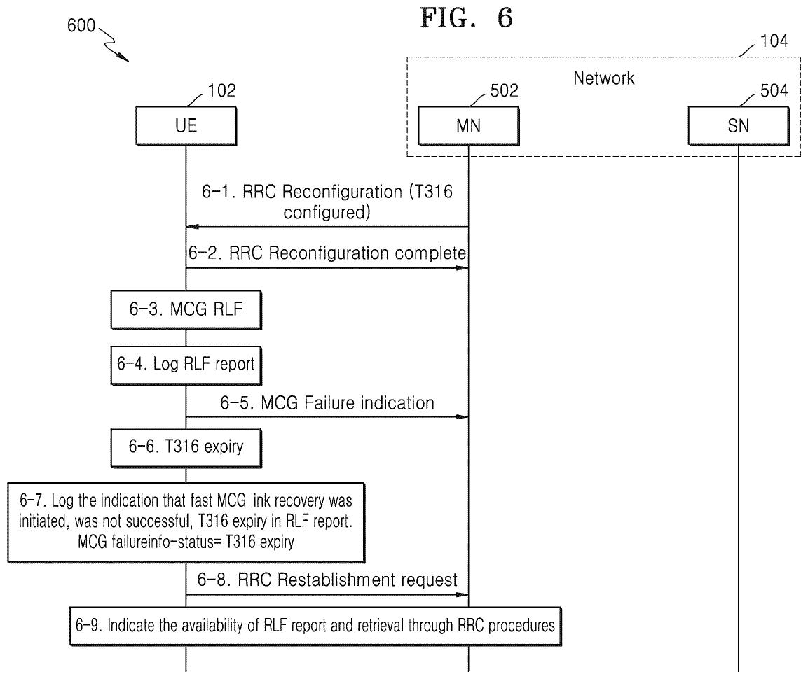

FIG. 6 is a flow diagram 600 depicting the fast MCG Link recovery behaviour, on T316 expiry. As depicted in step 6-1, the MN 502 of the network 104 transmits an RRC reconfiguration message comprising configuration of the fast MCG Link Recovery and the configured T316 timer. The UE 102 configures the fast MCG Link Recovery and transmits an RRC reconfiguration complete message to the MN 502, as depicted in step 6-2.

As depicted in step 6-3, an MCG RLF occurs in the UE 102 and the UE 102 logs the RLF report, as depicted in step 6-4. The UE 102 initiates the fast MCG link recovery and sends the MCG failure indication to the SN 504, as depicted in step 6-5. The UE 102 monitors for receiving the RRC response message within the configured T316 timer. If the RRC response message is not received before the T316 timer expires, as depicted in step 6-6, then the UE 102 logs the indication that the fast MCG link recovery was initiated, was not successful, and the T316 timer has expired during MCG link recovery in the RLF report (For example, MCGfailureinfo-status=T316expiry), as depicted in step 6-7. The RRC response message can comprise, but not limited to, an RRCConnectionReconfiguration message, an RRCReconfiguration message, a MobilityFromNRCommand message, a MobilityFromEUTRACommand message, and an RRCConnectionRelease message or RRCRelease message.

After logging the indication, the UE 102 transmits an RRC reestablishment request to the MN 502, as depicted in step 6-8. The UE 102 further indicates the availability of the RLF report and retrieval of the RLF report through RRC procedures to the MN 502 and the SN 504 of the network 104, as depicted in step 6-9.

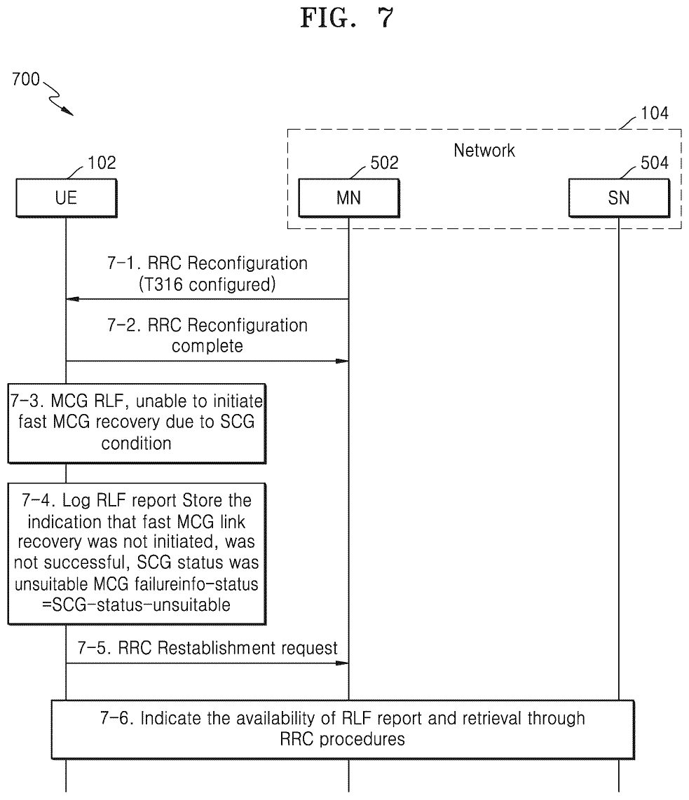

FIG. 7 is a flow diagram 700 depicting the fast MCG link recovery behaviour, when SCG status is unsuitable. As depicted in step 7-1, the MN 502 of the network 104 transmits an RRC reconfiguration message comprising configuration of the fast MCG Link Recovery and the configured T316 timer. The UE 102 configures the fast MCG link recovery and transmits an RRC reconfiguration complete message to the MN 502, as depicted in step 7-2.

As depicted in step 7-3, an MCG RLF occurs in the UE 102 and the UE 102 is unable to initiate the fast MCG link recovery due to SCG condition. As depicted in step 7-4, the UE 102 logs the RLF report and stores the indication that the fast MCG link recovery was not initiated, was not successful, and SCG status was unsuitable; for example, MCGfailureinfo-status=SCG-status-unsuitable.

After logging in the RLF report, the UE 102 transmits an RRC reestablishment request to the MN 502, as depicted in step 7-5. The UE 102 further indicates the availability of the RLF report and retrieval of the RLF report through RRC procedures to the MN 502 and the SN 504 of the network 104, as depicted in step 7-6.

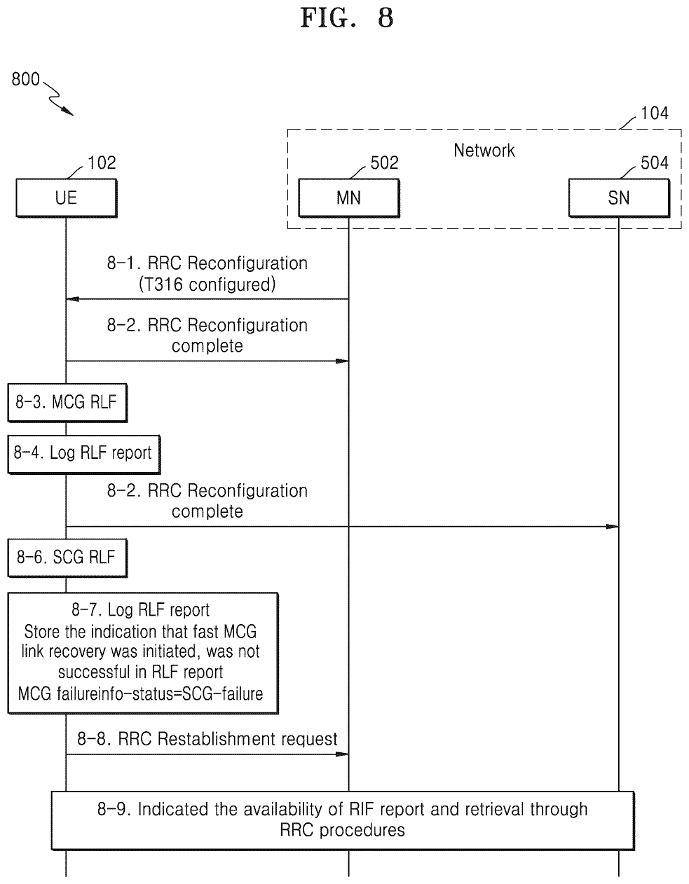

FIG. 8 is a flow diagram 800 depicting a fast MCG link recovery behaviour, when there is an SCG failure. As depicted in step 8-1, the MN 502 of the network 104 transmits an RRC reconfiguration message comprising configuration of the fast MCG link recovery and the configured T316 timer. The UE 102 configures the fast MCG link recovery and transmits an RRC reconfiguration complete message to the MN 502, as depicted in step 8-2. As depicted in step 8-3, an MCG RLF occurs in the UE 102 and the UE 102 logs the RLF report, as depicted in step 8-4.

After logging in the RLF report, the UE 102 transmits an MCG failure indication to the SN 504, as depicted in step 8-5. As depicted in step 8-6, an SCG RLF occurs in the UE 102. The UE 102 logs the RLF report and stores the indication that the fast MCG link recovery was initiated and was unsuccessful in the RLF report (For example, MCGfailureinfo-status=SCG-failure), as depicted in step 8-7.

After logging in the RLF report, the UE 102 transmits an RRC reestablishment request to the MN 502, as depicted in step 8-8. The UE 102 further indicates the availability of the RLF report and retrieval of the RLF report through RRC procedures to the MN 502 and the SN 504 of the network 104, as depicted in step 8-9.

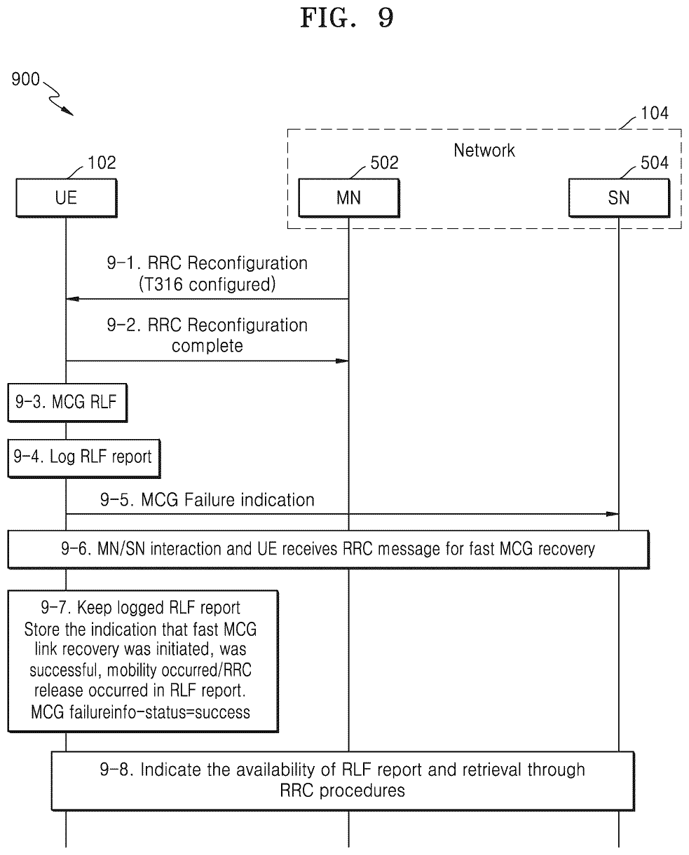

FIG. 9 is a flow diagram 900 depicting a successful fast MCG link recovery. As depicted in step 9-1, the MN 502 of the network 104 transmits an RRC reconfiguration message comprising configuration of the fast MCG link recovery and the configured T316 timer. The UE 102 configures the fast MCG link recovery and transmits an RRC reconfiguration complete message to the MN 502, as depicted in step 9-2. As depicted in step 9-3, an MCG RLF occurs in the UE 102 and the UE 102 logs the RLF report, as depicted in step 9-4.

After logging in the RLF report, the UE 102 transmits an MCG failure indication to the SN 504, as depicted in step 9-5. The UE 102 interacts with the MN 502/SN 504 and the UE 102 receives the RRC response message for the fast MCG link recovery, as depicted in step 9-6. As depicted in step 9-7, the UE 102 keeps logged RLF report and stores the indication that the fast MCG link recovery was initiated, was successful, and mobility occurred/RRC release occurred in the RLF report; for example, MCGfailureinfo-status=success. The UE 102 may log the timer related information such as elapsed timer value for T316 or the ratio between the elapsed timer and the configured timer for T316 in the RLF report, when the fast MCG link recovery has been successful. When the timer related information is logged while the fast MCG link recovery is successful, the UE may omit MCGfailureinfo-status.

After logging in the RLF report, the UE 102 further indicates the availability of the RLF report and retrieval of the RLF report through RRC procedures to the MN 502 and the SN 504 of the network 104, as depicted in step 9-8.

In an embodiment herein, the UE 102 includes above indications only if the UE 102 has been configured with split SRB1 or SRB3, and does not include the above indications if the UE 102 has not been configured with split SRB1 or SRB3.

In an embodiment herein, if the UE 102 which sent the MCG failure information, has received an RRC response message (such as an RRCConnectionReconfiguration message, an RRCReconfiguration message, a MobilityFromNRCommand message, a MobilityFromEUTRACommand message, and an RRCConnectionRelease message or RRCRelease message before T316 timer expiry), the UE 102 logs an indication that the fast MCG link recovery was successful in the RLF report. In an embodiment herein, if the UE 102 has received one of the RRCConnectionReconfiguration message, RRCReconfiguration message, MobilityFromNRCommand message, MobilityFromEUTRACommand message, then the UE 102 logs that there was a handover during the fast MCG link recovery. In an embodiment herein, if the UE 102 has received the RRCConnectionRelease message or RRCRelease message before T316 timer expiry, then the UE 102 logs that there was an RRC release during the fast MCG link recovery. In an alternate embodiment herein, the UE 102 logs that the fast MCG link recovery is successful only if the UE 102 has received an RRC response message (such as the RRCConnectionReconfiguration message, RRCReconfiguration message, MobilityFromNRCommand message, MobilityFromEUTRACommand message before T316 timer expiry) and does not log that the fast MCG link recovery is successful, if the UE 102 has received the RRCConnectionRelease message or RRCRelease message before T316 timer expiry.

In an embodiment herein, the UE 102 that supports SON/MDT enhancements for MCG failure, which has send MCGFailureInformation and has received an RRC response message (such as RRCConnectionReconfiguration message, RRCReconfiguration message, MobilityFromNRCommand message, MobilityFromEUTRACommand message, RRCConnectionRelease message or RRCRelease message) before T316 timer expiry, logs the RLF report and sends the logged RLF report to the network 104 based on request received from the network 104, in a RRC message like UE Information response.

If the UE 102 supports SON/MDT enhancements for MCG failure, the UE 102 docs not clear (for example, the UE 102 keeps/saves) the RLF report for this failure on reception of the RRC response message (such as RRCConnectionReconfiguration message, RRCReconfiguration message, MobilityFromNRCommand message, MobilityFromEUTRACommand message, RRCConnectionRelease message or RRCRelease message after sending MCGFailureInformation). If the UE 102 doesn't support SON/MDT enhancements for MCG failure, then the UE 102 clears the RLF report on reception of the RRC response message (such as RRCConnectionReconfiguration message, RRCReconfiguration message, MobilityFromNRCommand message, MobilityFromEUTRACommand message, RRCConnectionRelease message or RRCRelease message) after sending the MCG failure information.

In an embodiment herein, the network 104 may inform the UE 102 whether to keep the RLF report for the MCG failure or clear the RLF report for this failure on reception of the RRC response message (such as RRCConnectionReconfiguration message, RRCReconfiguration message, MobilityFromNRCommand message, MobilityFromEUTRACommand message, and RRCConnectionRelease message or RRCRelease message), after sending the MCG failure information. In an embodiment herein, the network 104 may communicate to the UE 102 through a flag in a RRC response message like RRC reconfiguration or RRC resume. If the UE 102 receives the above flag (and it is set as true), then the UE 102 does not clear (for example, the UE 102 saves/keeps) the RLF report for the MCG failure on reception of the RRC response message (such as RRCConnectionReconfiguration message, RRCReconfiguration message, MobilityFromNRCommand message, MobilityFromEUTRACommand message, and RRCConnectionRelease message or RRCRelease message), after sending the MCG failure information. Otherwise, the UE 102 clears the RLF report for the MCG failure on reception of the RRC response message (such as RRCConnectionReconfiguration message, RRCReconfiguration message, MobilityFromNRCommand message, MobilityFromEUTRACommand message, and RRCConnectionRelease message or RRCRelease message), after sending the MCG failure information.

In an embodiment herein, the UE 102 indicates to the network 104 that it is capable of keeping and reporting the RLF report for the MCG failure where the MCG failure information is initiated, on the reception of the RRC response message (such as RRCConnectionReconfiguration message, RRCReconfiguration message, MobilityFromNRCommand message, MobilityFromEUTRACommand message, RRCConnectionRelease message or RRCRelease message after sending the MCG failure information). The UE 102 may provide the above indication in RRC messages like UE capability information.

The UE 102 may just indicate that it is capable of supporting SON/MDT enhancements for the MCG failure information (fast MCG link recovery) and this may indicate that it is capable of keeping the RLF report for the failure where the MCG failure information is initiated, on the reception of RRC response message (such as RRCConnectionReconfiguration message, RRCReconfiguration message, MobilityFromNRCommand message, MobilityFromEUTRACommand message, RRCConnectionRelease message or RRCRelease message), after sending the MCG failure information. The UE 102 may provide the above indication in RRC messages like UE Capability Information.

The embodiments disclosed herein may be captured according to the below changes in T38.331.

```
  RLF-Report-r16 ::= CHOICE {
  <some text>
  [[
  lastHO-Type-r17 ENUMERATED {cho, daps, spare2, spare1} OPTIONAL,
  timeConnSourceDAPS-Failure-r17 TimeConnSourceDAPS-Failure-r17 OPTIONAL,
  timeSinceCHO-Reconfig-r17 TimeSinceCHO-Reconfig-r17 OPTIONAL,
  choCellId-r17 CHOICE {
  cellGlobalId-r17 CGI-Info-Logging-r16,
  pci-arfcn-r17 SEQUENCE {
  physCellId-r17 PhysCellId,
  carrierFreq-r17 ARFCN-ValueNR
  }
  }
  OPTIONAL,
  choCandidateCellList-r17 ChoCandidateCellList-r17 OPTIONAL
  ]],
  [[
  MCGfailureinfo-status ENUMERATED
{success,t316expiry,scg-failure,scgstatus-unsuitable,bearer-notconfigured,spare1,spare
2,spare3}
  ]]
  },
  }
```

### 5.3.10.3 Detection of Radio Link Failure

4> if AS security has not been activated:
5> perform the actions upon going to RRC_IDLE as specified in 5.3.11, with release cause ‘other’;
4> else if AS security has been activated but SRB2 and at least one DRB or multicast MRB or, for IAB, SRB2, have not been setup:
5> store the radio link failure information in the VarRLF-Report as described in clause 5.3.10.5;
5> If the UE supports SON/MDT enhancements for MCG failure and if T316 is configured;
6> set MCGfailureinfo-status to bearer-not configured in the VarRLF-Report for this failure.
5> perform the actions upon going to RRC_IDLE as specified in 5.3.11, with release cause ‘RRC connection failure’;
5> store the radio link failure information in the VarRLF-Report as described in clause 5.3.10.5;
5> if T316 is configured; and
5> if SCG transmission is not suspended; and
5> if the SCG is not deactivated; and
5> if neither PS Cell change nor PS Cell addition is ongoing (i.e., timer T304 for the NR PS Cell is not running in case of NR-DC or timer T307 of the E-UTRA PS Cell is not running as specified in TS 36.331 [10], clause 5.3.10.10, in NE-DC):
6> initiate the MCG failure information procedure as specified in 5.7.3b to report MCG radio link failure.
5> else:
6> If the UE supports SON/MDT enhancements for MCG failure and if T316 is configured;
7> set MCGfailureinfo-status to SCG-status-unsuitable in the VarRLF-Report for this failure.
6> initiate the connection re-establishment procedure as specified in 5.3.7.

### 5.7.3b.5T316 Expiry

The UE shall:
if T316 expires:
initiate the connection re-establishment procedure as specified in 5.3.7.
If the UE supports SON/MDT enhancements for MCG failure and
set MCGfailureinfo-status to T316expiry in the VarRLF-Report for this failure.
5.3.5.8 Reconfiguration failure
5.3.5.8.1 Void
5.3.5.8.2 Inability to comply with RRCReconfiguration
3> if MCG transmission is not suspended:
4> initiate the SCG failure information procedure as specified in clause 5.7.3 to report SCG reconfiguration error, upon which the connection reconfiguration procedure ends;
4> If the UE supports SON/MDT enhancements for MCG failure and if T316 is running;
5> set MCGfailureinfo-status to scg-failure in the VarRLF-Report for this failure.
5.3.5.8.3 T304 expiry (Reconfiguration with sync Failure) or T420 expiry (Path switch failure) else if T304 of a secondary cell group expires:
if MCG transmission is not suspended:
release dedicated preambles provided in rach-ConfigDedicated, if configured;
initiate the SCG failure information procedure as specified in clause 5.7.3 to report SCG reconfiguration with sync failure, upon which the RRC reconfiguration procedure ends;
If the UE supports SON/MDT enhancements for MCG failure and if T316 is running;
set MCGfailureinfo-status to SCG-failure in the VarRLF-Report for this failure.
5.3.8.3 Reception of the RRCRelease by the UE
if timer T316 is running;
stop timer T316;
If the UE does not support SON/MDT enhancements for MCG failure
clear the information included in VarRLF-Report, if any;
5.4.3.3 Reception of the MobilityFromNRCommand by the UE
if T316 is running:
stop timer T316;
If the UE does not support SON/MDT enhancements for MCG failure
clear the information included in VarRLF-Report, if any;
5.3.5.5.2 Reconfiguration with sync
if this procedure is executed for the MCG:
if timer T316 is running;
stop timer T316;
If the UE does not support SON/MDT enhancements for MCG failure
clear the information included in VarRLF-Report, if any;
5.3.10.5 RLF report content determination
if the fast MCG recovery procedure fails after detection of radio link failure at the MCG as described in 5.3.10.3:
if the timer T316 expires:
set the mcgRecoveryFailure-Cause to t316-expiry;
2> else if SCG was deactivated at the time of initiation of the fast MCG recovery procedure:
3> set the mcgRecoveryFailure-Cause to scgDeactivated;
3> if the timer T312 expires at the SCG while the timer T316 was running:
4> set mcgRecoveryFailure-Cause to scg-t312-Expiry;
3> else if the UE declares radio link failure at the SCG due to inability to comply with RRCReconfiguration
4> set the mcgRecoveryFailure-Cause as scg-rlf-other
If T316 was configured and AS security was activated and UE is configured with split SRB1 or SRB3 but the fast MCG recovery procedure was not initiated.
If SCG was deactivated at the time of initiation of fast MCG recovery procedure set the mcgRecoveryFailure-Cause to scgUnsuitable-Deactivated
else
set the mcgRecoveryFailure-Cause to UnInitiated-Other

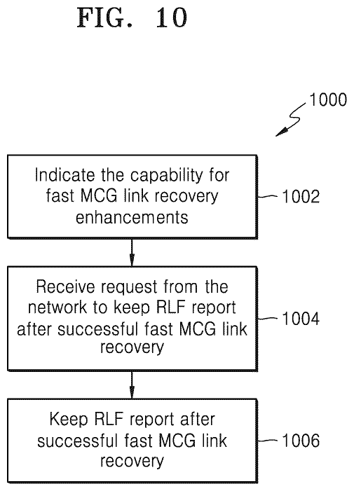

FIG. 10 illustrates a method 1000 for depicting a process of handling RLF reports during a successful fast MCG link recovery. The method 1000 includes indicating, by the UE 102, the capability for fast MCG link recovery enhancements, as depicted in step 1002. The method 1000 includes receiving, by the UE 102, a request from the network 104 to keep the RLF report after successful fast MCG link recovery, as depicted in step 1004. The method 1000 includes keeping, by the UE 102, the RLF report after successful fast MCG link recovery, as depicted in step 1006.

In an embodiment herein, if the UE 102 has stored the MCGfailureinfo-status (or the fast MCG link recovery related information) in the RLF report, on receiving handover related RRC messages (for example, RRCConnectionReconfiguration message, RRCReconfiguration message, MobilityFromNRCommand message, MobilityFromEUTRACommand message) or RRC Release messages (For example, RRCConnectionRelease message or RRCRelease message.) before T316 timer expiry, then the UE 102 saves the RLF report for the current RLF failure, informs about availability of the RLF report to the network 104 and sends the RLF report to the network 104 on request.

In an embodiment herein, if the UE 102 has not stored the MCGfailureinfo-status (or the fast MCG link recovery related information) in the RLF report, on receiving handover related RRC messages (for example, RRCConnectionReconfiguration message, RRCReconfiguration message, MobilityFromNRCommand message, MobilityFromEUTRACommand message) or RRC Release (RRCConnectionRelease message or RRCRelease message) before T316 timer expiry, then the UE 102 clears the RLF report for the current RLF failure.

In an embodiment herein, when MR-DC is configured, the network (gNB) 104 may request the UE 102 to store and report successful handover report (SHR) or Inter-RAT successful handover report (Inter-RAT SHR), if the fast MCG link recovery was performed for this handover (For example, the UE 102 received handover after MCGFailureInformation was send and while the T316 timer was running). Based on the configuration, the UE 102 stores and reports successful handover report (SHR) or Inter-RAT successful handover report (Inter-RAT SHR), if the handover occurred after MCGFailureInformation was send, For example, the UE 102 receives one of RRC message (such as RRCConnectionReconfiguration message, RRCReconfiguration message, MobilityFromNRCommand message, and MobilityFromEUTRACommand message for mobility), while the T316 timer was running. In an embodiment herein, the UE 102 may skip including location information or measurement information in the SHR or the inter-RAT SHR, if the location information or the measurement information is the same as the one in the stored RLF report for the MCG RLF, which triggered the MCG fast link recovery. The various actions in method 1000 may be performed in the order presented, in a different order or simultaneously. Further, in some embodiments, some actions listed in FIG. 10 may be omitted.

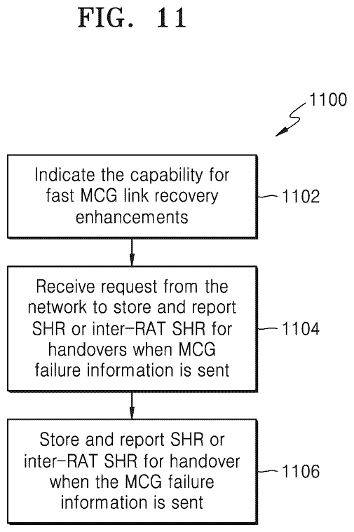

FIG. 11 illustrates a method 1100 depicting the process of handling SHR/Inter-RAT SHR during fast MCG link recovery. The method 1100 includes indicating, by the UE 102, the capability for fast MCG link recovery enhancements, as depicted in step 1102. The method 1100 includes receiving, by the UE 102, a request from the network 104 to store and report SHR or inter-RAT SHR for handovers when MCG failure information is sent, as depicted in step 1104. The method 1100 includes storing and reporting the SHR or inter-RAT SHR for handover when the MCG failure information is sent, as depicted in step 1106. The various actions in method 1100 may be performed in the order presented, in a different order or simultaneously. Further, in some embodiments, some actions listed in FIG. 11 may be omitted.

In an embodiment herein, when MR-DC is configured, the UE 102 may be configured with a threshold percentage for T316 timer. If T316 timer was running while the handover or PS Cell change or PS Cell addition occurred and T316 timer value is higher than the configured threshold, the UE 102 stores successful handover report (SHR), Inter-RAT successful handover report (SHR) or successful PS Cell change report (SPCR) or successful PS Cell Addition report (SPAR) and delivers it to the gNB when requested.

An example spec extract illustrating SuccessHO-Config is shown below:

```
  SuccessHO-Config-r18 ::= SEQUENCE {
  OnMCGFailureInformationReport ENUMERATED {true}
  thresholdPercentageT316-r18 ENUMERATED {p0,p20, p40, p60, p80,
spare4, spare3, spare2, spare1} OPTIONAL, -- Need M
  ...
  }
```

If the ratio between the value of the elapsed time of the timer T316 and the configured value of the timer T316 is greater than the threshold percentage of T316 included in the successHO-Config or successful PS Cell change configuration or successful PS Cell addition configuration received before executing the handover/PS Cell change/PS Cell addition, then the UE 102 stores SHR/Inter-RAT SHR/SPAR/SPCR and delivers the stored SHR/Inter-RAT SHR/SPAR/SPCR to the gNB when requested.

In an embodiment herein, a UE which supports SON/MDT enhancements for fast MCG link recovery includes the following additional information within the MCG failure information message and sends to the SN 504.

Location Information, if available

If the failure is due to random access problem, the random access report.

Available sensor information like Bluetooth/WLAN information. In an embodiment, the UE includes this additional information only when gNB requests the UE to do so. The gNB may request the UE to provide the additional information through a flag in RRC messages like RRC Reconfiguration or RRC Resume.

In an embodiment herein, the UE 102 sends to the network 104 that it is capable of storing and reporting successful handover report (SHR) or Inter-RAT successful handover report (Inter-RAT SHR), when the fast MCG link recovery was performed for this handover. The UE 102 may provide the above indication in RRC messages like UE Capability Information.

The UE 102 may indicate that it is capable of supporting SON/MDT enhancements for MCG failure information (fast MCG link recovery) and this may indicate that the UE 102 is also capable of storing and reporting successful handover report (SHR) or Inter-RAT successful handover report (Inter-RAT SHR), when the fast MCG link recovery was performed for this handover. The UE 102 may provide the above indication in RRC messages like UE capability information.

In an embodiment herein, if the UE 102 was registered with a standalone non-public network (SNPN), when the radio link failure occurred, then the UE 102 stores the NPN identifier of the SNPN where the UE 102 was registered in the RLF report. The UE 102 may store this information in the npn-IdentityInfoList within the RLF report.

In an embodiment herein, if the UE 102 has RLF reports available and if the registered SNPN is included in npn-IdentityInfoList stored in the report, then the UE 102 includes an indication that the RLF report is available in one of the RRC setup complete message, the RRC resume complete message or the RRC reestablishment complete message.

In an embodiment herein, when the UE 102 receives a request to report an RLF report in a RRC message like UE information request, then the UE 102 includes the RLF report in the RRC message (like the UE Information Response), if the registered SNPN is included in npn-IdentityInfoList which is stored in the report.

The embodiments disclosed herein can be implemented through at least one software program running on at least one hardware device and performing network management functions. The elements shown in FIGS. 1 and 2 include blocks which can be at least one of a hardware device, or a combination of hardware device and software module.

The embodiment disclosed herein describes methods and systems for handling the MCG link recovery for Multi Radio-Dual Connectivity (MR-DC) scenarios in wireless communication networks. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the spirit and scope of the embodiments as described herein.

1. A method (300, 400, 500, 600, 700, 800, 900, 1000, 1100) performed by a user equipment (UE) (102) supporting a fast Master Cell Group (MCG) link recovery for Multi Radio-Dual Connectivity (MR-DC), comprising:
initiating the fast MCG link recovery, based on occurrence of a radio link failure (RLF) in MCG; and
in case that failure of the fast MCG link recovery is identified, transmitting a RLF report including cause information indicating at least one of expiry of a timer, secondary cell group (SCG) deactivation or SCG failure.

2. The method (300, 400, 500, 600, 700, 800, 900, 1000, 1100) of claim 1, further comprising: logging and reporting the fast MCG link recovery, when the fast MCG link recovery has not been initiated due to at least one of: an SCG transmission has been suspended, a Primary and Secondary cell (PS Cell) change/PS Cell addition is ongoing, reconfiguration with synchronous (sync) failure for SCG while MCG has been suspended, an Access stratum (AS) security has not been activated, and a Data Radio Bearer (DRB)/Multicast Radio Bearer (MRB) or a Signaling Radio Bearer (SRB) has not been configured.

3. The method (300, 400, 500, 600, 700, 800, 900, 1000, 1100) of claim 1, wherein the RLF report indicates the status comprising at least one of the fast MCG link recovery has not been initiated, the fast MCG link recovery has been initiated and was successful, and the fast MCG link recovery has been initiated and was unsuccessful.

4. The method (300, 400, 500, 600, 700, 800, 900, 1000, 1100) of claim 1, further comprising logging a plurality of information in the RLF report to indicate the status of the fast MCG link recovery, when the fast MCG link recovery has not been initiated or was unsuccessful, and wherein the plurality of information comprises at least one of a Secondary Cell Group (SCG) was deactivated at the time of initiation of the fast MCG link recovery, the UE (102) has not been received the RRC response message from the network (104) within the configured timer, a RLF at SCG, a configured timer (T312) expired at SCG, and common failures at SCG.

5. The method (300, 400, 500, 600, 700, 800, 900, 1000, 1100) of claim 1, wherein the RRC response message from the network (104) comprises at least one of a mobility from New Radio (NR) command message, a mobility from Evolved Universal Terrestrial Radio Access (EUTRA) command message, an RRC reconfiguration message, and an RRC release message.

6. The method (300, 400, 500, 600, 700, 800, 900, 1000, 1100) of claim 1, further comprising: transmitting at least one UE capability information to the network (104) informing whether the UE is capable of supporting of Self-Organizing Network (SON)/Minimization of Drive Test (MDT) enhancements for the fast MCG link recovery.

7. The method (300, 400, 500, 600, 700, 800, 900, 1000, 1100) of claim 1, further comprising:
detecting that the fast MCG link recovery has been initiated and was successful;
verifying at least one condition comprising:
if the UE (102) supports the SON/MDT enhancements for the fast MCG link recovery, and
if the UE (102) has logged the plurality of information about the fast MCG link recovery in the RLF report;
storing the logged RLF report and sending the logged RLF report to the network (104), if the at least one condition is satisfied; and
releasing the logged RLF report, if the at least one condition is not satisfied.

8. A User Equipment (UE) (102), comprising:
a transceiver; and
a processor (106) coupled with the transceiver and configured to:
initiate a fast master cell group (MCG) link recovery, based on occurrence of a radio link failure (RLF) in MCG;
in case that failure of the fast MCG link recovery is identified, transmit a RLF report including cause information indicating at least one of expiry of a timer, secondary cell group (SCG) deactivation or SCG failure.

9. The UE (102) of claim 8, wherein the processor is configured to log and report the fast MCG link recovery, when the fast MCG link recovery has not been initiated due to at least one of: an SCG transmission has been suspended, a Primary and Secondary cell (PS Cell) change/PS Cell addition is ongoing, reconfiguration with synchronous (sync) failure for SCG while MCG has been suspended, an Access stratum (AS) security has not been activated, and a Data Radio Bearer (DRB)/Multicast Radio Bearer (MRB) or a Signaling Radio Bearer (SRB) has not been configured.

10. The UE (102) of claim 8, wherein the RLF report indicates the status comprising at least one of the fast MCG link recovery has not been initiated, the fast MCG link recovery has been initiated and was successful, and the fast MCG link recovery has been initiated and was unsuccessful.

11. The UE (102) of claim 8, wherein the processor is configured to log a plurality of information in the RLF report to indicate the status of the fast MCG link recovery, when the fast MCG link recovery has not been initiated or was unsuccessful, and wherein the plurality of information comprises at least one of a Secondary Cell Group (SCG) was deactivated at the time of initiation of the fast MCG link recovery, the UE (102) has not been received the RRC response message from the network (104) within the configured timer, a RLF at SCG, a configured timer (T312) expired at SCG, and common failures at SCG.

12. The UE (102) of claim 8, wherein the RRC response message from the network (104) comprises at least one of a mobility from New Radio (NR) command message, a mobility from Evolved Universal Terrestrial Radio Access (EUTRA) command message, an RRC reconfiguration message, and an RRC release message.

13. The UE (102) of claim 8, wherein the processor (106) is configured to send at least one UE capability information to the network (104) informing whether the UE (102) is capable of supporting of Self-Organizing Network (SON)/Minimization of Drive Test (MDT) enhancements for the fast MCG link recovery.

14. The UE (102) of claim 8, wherein the processor (106) is configured to:
detect that the fast MCG link recovery has been initiated and was successful;
verify at least one condition comprising:
if the UE (102) supports the SON/MDT enhancements for the fast MCG link recovery, and
if the UE (102) has logged the plurality of information about the fast MCG link recovery in the RLF report;
store the logged RLF report and send the logged RLF report to the network (104), if the at least one condition is satisfied; and
release the logged RLF report, if the at least one condition is not satisfied.

15. A network (104), comprising:
a transceiver; and
a processor (112) coupled with the transceiver and configured to:
receive at least one User Equipment (UE) capability information from a UE (102), wherein the at least one UE capability information informs whether the UE (102) is capable of supporting of Self-Organizing Network (SON)/Minimization of Drive Test (MDT) enhancements for a fast Master Cell Group (MCG) link recovery;
receive a Radio Link Failure (RLF) report from the UE (102) indicating the status of the fast MCG link recovery, if an RLF has occurred in MCG and the UE (102) is capable of supporting the SON/MDT enhancements for the fast MCG link recovery; and
perform a plurality of optimizing procedures for optimizing mobility of the UE (102) using the received status of the fast MCG link recovery.
